(19) United States
(12) Patent Application Publication
(10) Pub. No.: US 2016/0114245 A1
(43) Pub. Date: Apr. 28, 2016

(54) INFORMATION PROCESSING DEVICE AND GAME PROGRAM

(71) Applicant: DeNA Co., Ltd., Tokyo (JP)

(72) Inventors: Keisuke TAGAWA, Tokyo (JP); Masashi TSURUKAWA, Tokyo (JP)

(21) Appl. No.: 14/859,010

(22) Filed: Sep. 18, 2015

(30) Foreign Application Priority Data
Oct. 22, 2014 (JP) 2014-215246

(51) Int. Cl. A63F 13/45; A63F 13/30

(52) U.S. Cl. CPC A63F 13/45; A63F 13/30

(57) ABSTRACT

The information processing device according to the present invention is provided with a storage module that stores usage information on game content objects used in a game by each of multiple players, in association with each player; a statistical data generation module that generates statistical information on the usage of the game content objects by aggregating the usage information on each of the multiple game content objects; and a screen data generation module that generates data for game screens, which includes at least one of statistical information on the game content objects designated by the players when operations for designating game content objects are performed by the players, or value information on the game content objects that indicates the utility value of the game content objects based on said statistical information.

The present application claims the benefit of foreign priority under 35 USC 119 to Japanese Patent Application No. 2014-215246, filed on Oct. 22, 2014, the contents of which is incorporated herein in its entirety by reference.

### BACKGROUND

1. Field

The present invention relates to an information processing device and a game program (e.g., non-transitory computer-readable medium containing instructions stored in a storage and executable on a hardware device).

2. Related Art

There are well-known game systems in which a battle against a character encountered on a game field is initiated and a game content object (e.g., a character card) is provided to a player in accordance with the outcome of the battle (for example, see Patent Document 1).

### PRIOR ART DOCUMENT

### Patent Document

[Patent Document 1] Japanese Patent Application 2013-013509

### Problems to be Solved by the Invention

In such a game, rarity may be configured for each game content object. The players usually can conduct the game to their advantage if they obtain a high-rarity game content object. On the other hand, a low-rarity game content object is unlikely to significantly influence the progress of the game. However, even a low-rarity game content object may be turned into a powerful game content object through cultivation or fusion with other game content objects.

For this reason, when obtaining low-rarity game content objects, players have been unable to determine whether said game content objects should be cultivated and so forth, or disposed of as unnecessary game content objects. Although information sources used to determine this include, for example, informal website forums and the like used to post information relating to the utility of game content objects on the internet, accessing such informal website forums whenever a player obtains a game content object is time-consuming and, in addition, the information posted may turn out to be inaccurate.

### SUMMARY

The present invention was devised by taking such circumstances into consideration, and it is an object of the invention to provide a game in which the players can obtain more precise information on the utility of game content objects without spending a lot of time or effort.

### Means for Solving the Problems

In order to solve the above-described problems, the main aspect of the present invention is an information processing device provided with:

a storage module that stores usage information on game content objects used in a game by each of multiple players, in association with each player;

a statistical data generation module that generates statistical information on the usage of each of multiple game content objects by aggregating the usage information on each game content object; and

a screen data generation module that generates data for game screens, which includes at least one of statistical information on the game content objects designated by the players when operations for designating the game content objects are performed by the players, or value information on the game content objects that indicates the utility value of the game content objects based on said statistical information.

Other features of the present invention will become apparent from this Specification and the accompanying Drawings.

### DRAWINGS

FIG. 1 A diagram illustrating an example configuration of the entire game system 1.

FIG. 2 A block diagram illustrating the functional configuration of the server device 10.

FIG. 3 A diagram illustrating an example data structure of item information.

FIG. 4 A diagram illustrating an example data structure of character information.

FIG. 5 A diagram illustrating an example data structure of fusion information for a character.

FIG. 6 A diagram illustrating an example data structure of player information.

FIG. 7 A diagram illustrating an example data structure of proprietary character information.

FIG. 8 A diagram illustrating an example data structure of deck configuration information.

FIG. 9 A diagram illustrating an example data structure of reference book information.

FIG. 10 A diagram illustrating an example data structure of stage progression information.

FIG. 11 A diagram illustrating an example data structure of usage information.

FIG. 12 A block diagram illustrating the functional configuration of the player terminal 20.

FIG. 13 A flowchart illustrating a workflow associated with providing information on the utility of game content objects (characters) to the players in the game system 1.

FIG. 14 A diagram illustrating an exemplary game screen 50 used for designating characters.

FIG. 15 A diagram illustrating an exemplary game screen 60 used for displaying character information.

FIG. 16 A diagram illustrating an exemplary game screen 70 used for displaying character information with some of the information hidden.

### DETAILED DESCRIPTION

At least the following will become apparent from this Description and the accompanying Drawings.

Specifically, this is an information processing device provided with

a storage module that stores usage information on game content objects used in a game by each of a plurality of players, in association with each player;

a statistical data generation module that generates statistical information on the usage of the game content objects by aggregating the usage information on each of the plurality of game content objects; and

a screen data generation module the generates data for game screens, which includes at least one of statistical information on the game content objects designated by the players when operations for designating game content objects are performed by the players, or value information on the game content objects that indicates the utility value of the game content objects based on said statistical information.

Such an information processing device allows the players to acquire precise information on the utility of a game content object without spending a lot of time or effort because value information and statistical information are generated based on the actual usage of said game content object by multiple players. Therefore, it becomes easier for the players to determine whether or not to keep a game content object.

In this information processing device, the statistical data generation module may be adapted to aggregate usage information on each of the plurality of game content objects separately for each stage of progress in the game of each player, and the screen data generation module may be adapted to generate data for game screens, which includes at least one of value information on the game content objects or statistical information on the game content objects designated by the players in accordance with the stage of progress of the players who perform operations for designating the game content objects.

Such an information processing device allows the players to obtain precise information relating to the degree of utility of a game content object to players of equal strength. In addition, knowing the degree of utility of a game content object to stronger players makes it easier to determine whether to keep or dispose of the game content object.

In addition, in this information processing device, the screen data generation module may be adapted to generate data for game screens, which includes at least one of value information on the game content objects or statistical information on transformed game content objects pre-associated with the game content objects designated when operations for designating game content objects are performed by the players.

If a game content object is evolved, such an information processing device makes it possible for the players to obtain information relating to the degree of utility of the evolved game content object. Therefore, it becomes easier for the players to determine whether or not a game content object is to be evolved.

In addition, in this information processing device, the statistical data generation module may be adapted to aggregate usage information only on the game content objects currently owned by the player among the game content objects used by the player in the game.

Since in such an information processing device usage information is extracted and aggregated based on information on the game content objects currently owned by the players, the players can obtain accurate statistical information corresponding to the actual game content usage of other players. Therefore, it becomes easier for the players to make an accurate determination as to whether or not a game content object actually possesses utility value.

In addition, this information processing device may be provided with a game content provision module providing the players with game content objects selected from multiple game content objects and

the screen data generation module may be adapted to generate data for game screens, which includes at least one of value information on the game content objects or statistical information on game content objects provided when said game content objects are provided to the players.

Such an information processing device allows the players to acquire precise information on the utility of game content objects obtained in a lottery game, or the like, without spending a lot of time or effort. Therefore, it becomes easier to determine whether or not to keep an acquired game content object.

In addition, in the information processing device, all or some of the value information on the game content objects or statistical information on the game content objects designated by the players when operations for designating game content objects are performed by the players may be controlled by the screen data generation module based on predetermined criteria such that the information is prevented from being displayed on the screen.

If a game content object is unknown to the players, such an information processing device makes it possible to heighten their interest as a result of stimulating the imagination of the players by not displaying at least some of the information relating to said unknown game content objects. In addition, by displaying only some of the information, the players can be made to anticipate owning said game content objects.

Next, this is a game program non-transitory computer-readable medium containing instructions stored in a storage and executable on a hardware device that directs a computer to execute:

a process intended to record usage information on game content objects used in a game by each of a plurality of players in a storage module, in association with each player;

a statistical data generation process for generating statistical information on the usage of the game content objects by aggregating the usage information on each of the plurality of game content objects; and

a screen data generation process for generating data for game screens, which includes at least one of statistical information on the game content objects designated by the players when operations for designating game content objects are performed by the players, or value information on the game content objects that indicates the utility value of the game content objects based on said statistical information.

Such a game program allows the players to acquire precise information on the utility of game content objects without spending a lot of time or effort.

### EMBODIMENTS

### Configuration of Game System 1

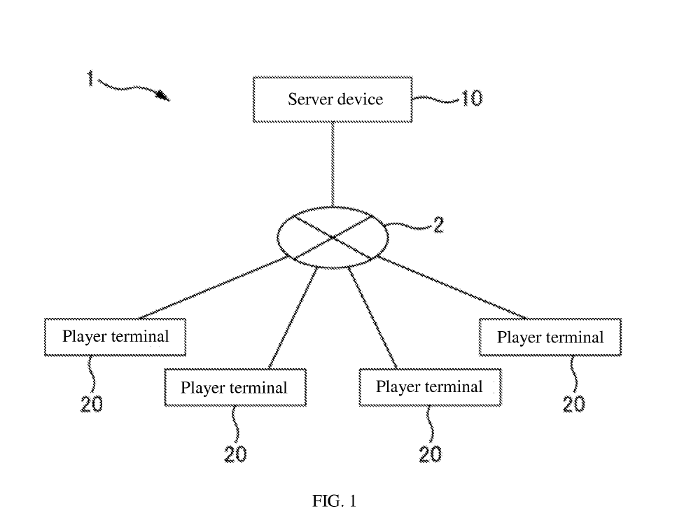

FIG. 1 is a diagram illustrating an example configuration of the entire game system 1. The game system 1 provides various game-related services to the player over a network 2 (for example, the Internet) and includes a server device 10 and multiple player terminals 20.

The game system 1 can provide players with a lottery game intended to acquire character cards (hereinafter referred to simply as “characters”), as an example of game content objects, or a battle game to be conducted using the acquired characters. In the lottery game, game content objects selected from a game content object group comprising multiple game content objects are provided to the players who issue a game content object (character) acquisition request. Furthermore, in the battle game, the player characters belonging to the players are directed to engage in battle with enemy characters. In the course of the battle, the players wage the battle by forming decks using characters selected from the multiple characters they own. At such time, player characters owned by other players can serve as support characters and be used by configuring them as part of the players' decks.

In the game system 1 according to the present embodiment, the usage of the characters used by each of the multiple players in the battle game, or the like, is aggregated and managed as statistical information on the use of the characters. Subsequently, if a player designates this character or if this character is acquired in a lottery game, or the like, a game screen that includes statistical information on game content objects or value information based on said statistical information is generated and displayed.

The player determines the utility of a character by referring to the statistical information or value information on the game content objects displayed on the game screen, thereby facilitating decision-making on the usage of said character. For example, it becomes easier to determine whether said character is to be discarded as unnecessary, or kept and cultivated.

### <<Configuration of Server Device 10>>

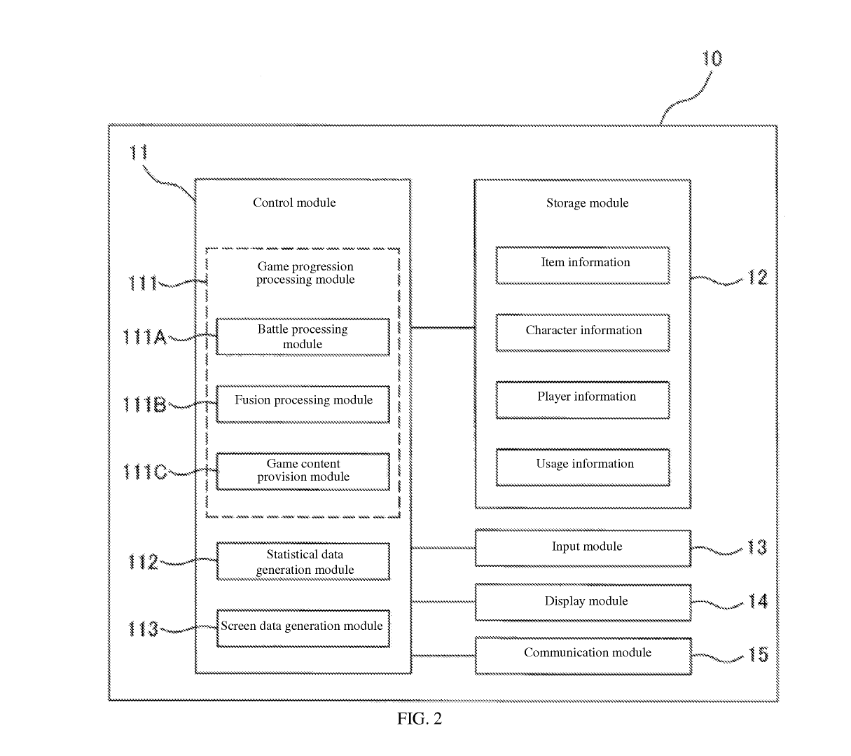

FIG. 2 is a block diagram illustrating the functional configuration of the server device 10. The server device 10 is an information processing device (for example, a workstation, a personal computer, etc.) used by a system administrator to operate and manage a variety of services. Upon receiving various commands (requests) from player terminals 20, the server device 10 transmits (responds by sending) game programs operational on the player terminals 20 and various types of data and web pages (game screens, etc.) created using a markup language (HTML, etc.) compliant with the specifications of the player terminals 20. The server device 10 has a control module 11, a storage module 12, an input module 13, a display module 14, and a communication module 15.

The control module 11, along with transferring data between the components, exercises overall control over the server device 10, and is implemented using a CPU (Central Processing Unit) that runs a predetermined program (e.g., non-transitory computer-readable medium containing instructions stored in a storage and executable on a hardware device) stored in memory. The control module 11 of the present embodiment is provided with a game progression processing module 111, a statistical data generation module 112, and a screen data generation module 113.

The game progression processing module 111 possesses functionality to carry out processing required for directing the game to proceed in accordance with the game program. This game progression processing module 111 is provided with at least a battle processing module 111A, a fusion processing module 111B, and a game content provision module (lottery drawing module) 111C.

The battle processing module 111A possesses functionality to carry out various types of battle game-related processing. The fusion processing module 111B possesses functionality to carry out various types of processing related to game content fusion. In the present embodiment, fusion processing includes processing intended to provide new parameters and capabilities (skills) to an original pre-fusion character by combining and fusing it with multiple game content objects (characters and items) (for convenience, such processing is also called “awakening”) and processing intended to generate a character of a different type than the original pre-fusion character (for convenience, such processing is also called “evolution”). The game content provision module 111C possesses functionality to execute processing used for providing game content objects to the players. In the present embodiment, the game content provision module 111C possesses functionality to provide the players with game content objects selected via a lottery from a game content object group made up of multiple game content objects. In other words, the game content provision module 111C is a lottery processing module that executes various types of lottery game-related processing.

The statistical data generation module 112 aggregates usage information on the game content objects used by each of the multiple players in the game separately for each game content object and generates statistical information on the usage of each game content object.

The screen data generation module 113 possesses functionality to carry out processing used to generate screen data for displaying a game screen on a player terminal 20. The screen data generation module 113 of the present embodiment generates HTML data as screen data corresponding to a game screen.

The storage module 12 has a ROM (Read Only Memory), which is a read-only storage area where operating system software is stored, and a RAM (Random Access Memory), which is a rewritable storage area used as a work area for arithmetic processing by the control module 11, and is implemented as a non-volatile storage device, such as a flash memory, a hard disk, or the like. The storage module 12 of the present embodiment stores item information, character information, player information, usage information, and various other types of data.

The input module 13, which is used by a system administrator to enter various types of data (e.g., character information, etc.), is implemented, for example, as a keyboard, a mouse, or the like.

The display module 14, which is used for displaying operation screens used by the system administrator in response to commands from the control module 11, is implemented using a liquid crystal display (LCD: Liquid Crystal Display), or the like.

The communication module 15, which operates as a transceiver module used for transmitting and receiving various types of information to and from the player terminals 20 over a network 2, is implemented using an NIC (Network Interface Card), or the like.

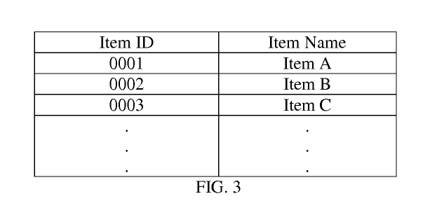

FIG. 3 is a diagram illustrating an example data structure of item information. Such item information has configured therein at least item names in association with item IDs.

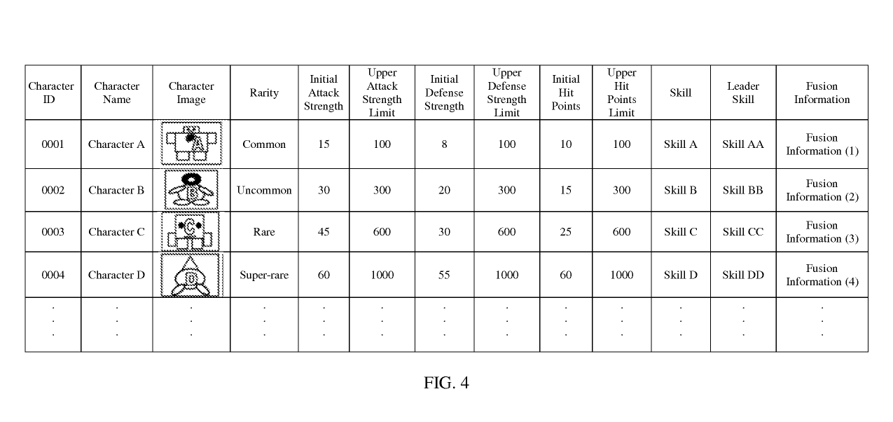

FIG. 4 is a diagram illustrating an example data structure of character information. Such character information has configured therein, in association with character IDs, at least a character name, a character image, rarity classified into multiple levels (e.g., R1 “common”→R2 “uncommon”→R3 “rare”→R4 “super-rare”→R5 “extremely super-rare”→R6 “ultra-rare”), initial attack strength, upper attack strength limit, initial defense strength, upper defense strength limit, initial hit points, upper hit point limit, and various other parameters, skills that the character can display in the battle game, leader skills used when the character is configured as a leader character, as well as fusion information for the character.

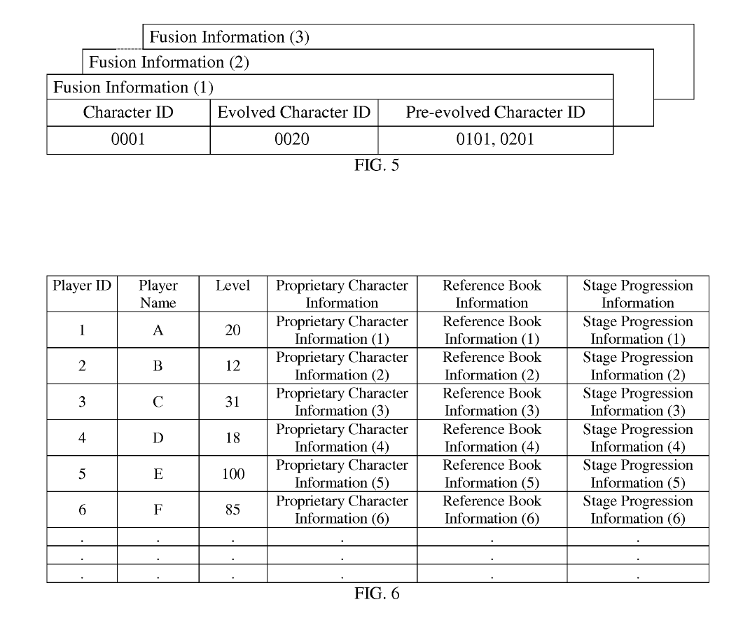

FIG. 5 is a diagram illustrating an example data structure of fusion information for a character. Such fusion information has configured therein, in association with character IDs, at least the IDs of evolved characters and the IDs of pre-evolved characters. The term “evolved characters” refers to transformed characters pre-associated with the characters. In other words, these are new characters generated by fusing this character as source material. The term “pre-evolved characters” refers to pre-transformation characters that are pre-associated with the character. In other words, these are characters that serve as the source material for fusing the character.

FIG. 6 is a diagram illustrating an example data structure of player information. Such player information has configured therein, in association with player IDs, at least a player name, a level (or player's rank), proprietary character information, i.e. information on the characters currently owned by the player (hereinafter referred to as “proprietary characters”), reference book information, i.e. information on the characters that the player has owned from the beginning of the game up till now, and stage progression information relating to stage progression in the course of the game.

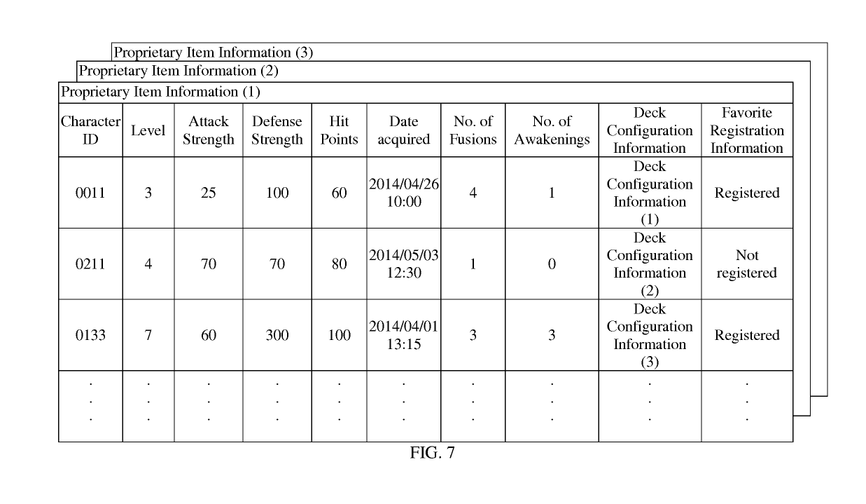

FIG. 7 is a diagram illustrating an example data structure of proprietary character information. Such proprietary character information has configured therein, in association with the character ID of a proprietary character, at least a level, attack strength, defense strength, various other parameters of hit points, the date and time when the character was acquired, the number of times the character has been fused, the number of times the character has been awakened, deck configuration information, and favorite registration information. The use of “favorite registration” makes it possible to facilitate searching for characters and indicate one's favorite characters to other players by registering predetermined characters selected by the player among the proprietary characters as favorite characters. In addition, predetermined information among the various types of information configured in the proprietary character information is configured as usage information.

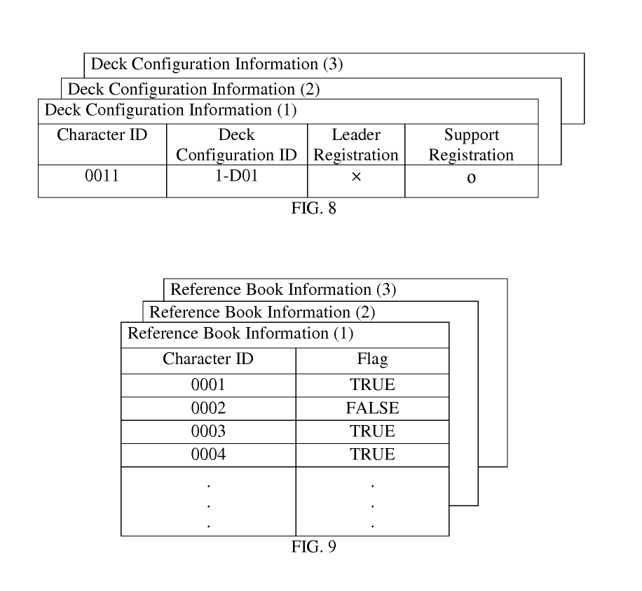

FIG. 8 is a diagram illustrating an example data structure of deck configuration information. The deck configuration information (i.e. information relating to the decks formed by the players) constitutes information describing a team made up of multiple characters used in a battle game. Such deck configuration information has configured therein, in association with a character ID, at least the ID of the deck in which the character is configured, leader character registration information, and support character registration information. “Leader characters” are characters registered as deck leaders and characters registered as leader characters are capable of obtaining advantageous effects, such as deploying leader skills, and so forth, in the battle game. In addition, “support characters”, which are characters serving as assistants to other players during a battle game as a result of being configured in the decks of other players, are registered in advance by the players. For example, if Character A owned by Player A is registered as a support character and Player B selects Character A as a support character, Player B can conduct the battle game with Character A included in his own deck and, as a result, Player A can obtain in-game currency and other rewards from Player B.

FIG. 9 is a diagram illustrating an example data structure of reference book information. Such reference book information has configured therein, in association with the character IDs of proprietary characters, at least flag information and used stage information. The flag information is set to “TRUE” if the player has owned the character heretofore, and to “FALSE” if the player has never owned it. The used stage information has configured therein the IDs of the stages in which this character has been used heretofore.

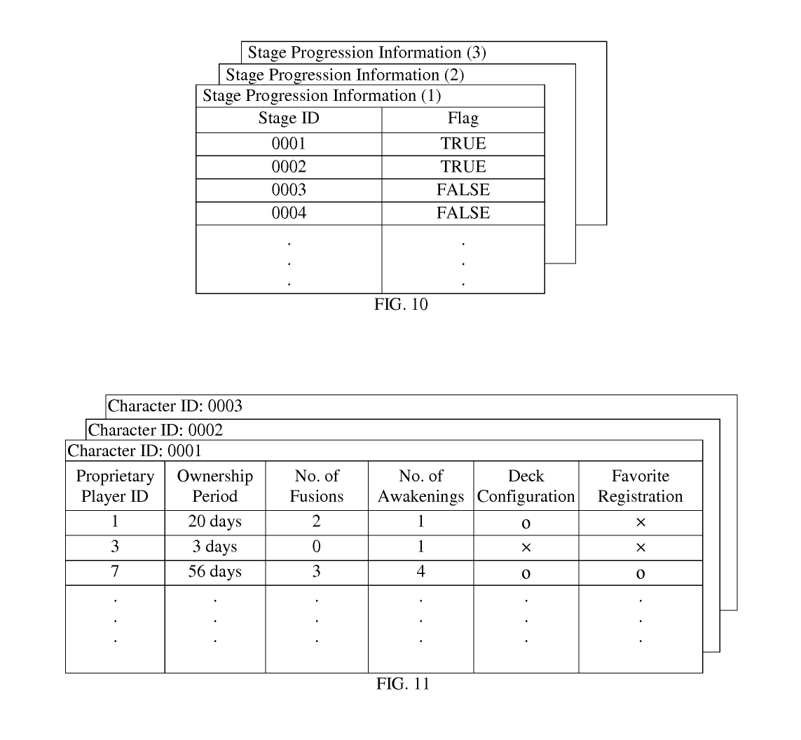

FIG. 10 is a diagram illustrating an example data structure of stage progression information. Such stage progression information has configured therein at least flag information in association with stage IDs. The flag information is set to “TRUE” for stages that have been cleared heretofore, and to “FALSE” for stages that have never been cleared.

FIG. 11 is a diagram illustrating an example data structure of usage information. The usage information is information summarizing the usage of the game content objects (characters) used by each of the multiple players in the game. In the present embodiment, predetermined information is extracted from each player's proprietary character information and stored as usage for each character. Such usage information has configured therein, for each character, in association with the ID of the player who owns this character, at least an ownership period from the time when the character was acquired until the present time, the number of times the character has been fused, the number of times the characters has been awakened, the deck configuration status of the character, and its favorite registration status.

### <<Configuration of Player Terminal 20>>

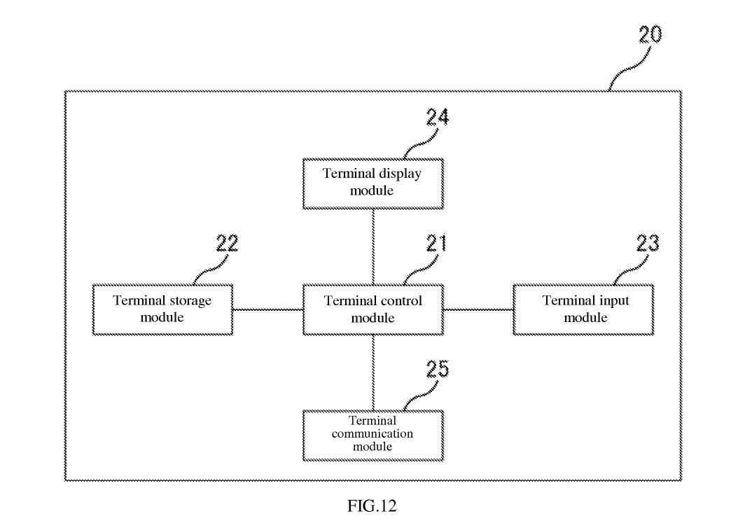

FIG. 12 is a block diagram illustrating the functional configuration of a player terminal 20. The player terminals 20 are information processing devices owned and used by the players (e.g., tablet terminals, mobile phone terminals, smartphones, and the like). Due to the web browser functionality they possess, the player terminals 20 are capable of on-screen display of web pages (game screens, and the like) transmitted from the server device 10. A player terminal 20 has a terminal control module 21 used for overall control of the player terminal 20, a terminal storage module 22 used for storing various types of data and programs (e.g., non-transitory computer-readable medium containing instructions stored in a storage and executable on a hardware device), a terminal input module 23 used by the player for operation input, a terminal display module 24 used for displaying game screens and operation screens, and a terminal communication module 25 used for communicating information to and from the server device 10.

### <<Operation of Game System 1>>

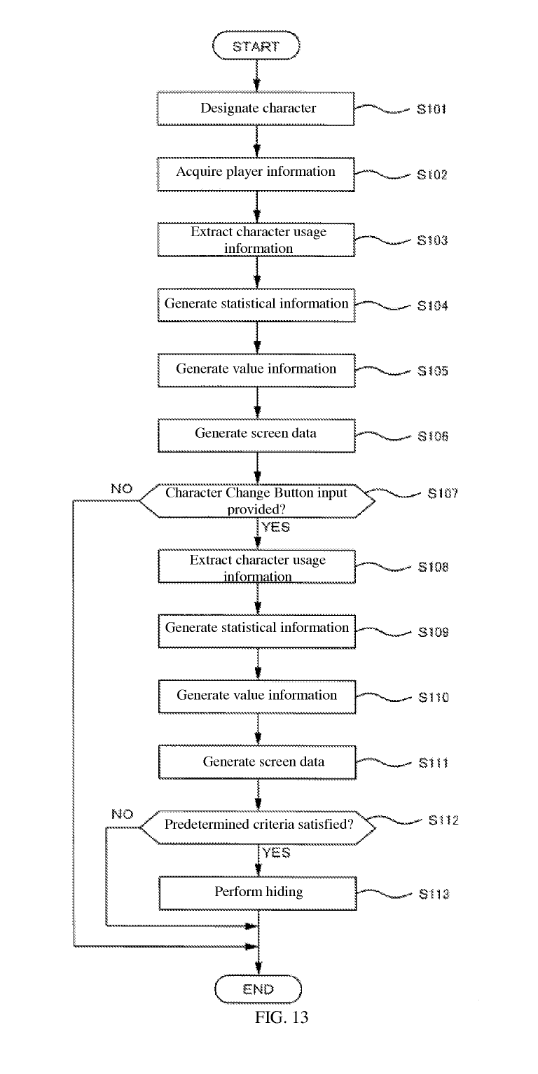

FIG. 13 is a flowchart illustrating a workflow associated with providing information on the utility of game content objects (characters) to the players in the game system 1.

First of all, the player terminal 20 uses screen data transmitted from the server device 10 to display a game screen used for designating characters on the terminal display module 24, thereby allowing the player to designate a character from among the multiple characters about which he or she would like to obtain information (S101). Subsequently, when the player performs an operation to select a particular character, a command requesting transmission of a game screen (game screen transmission request) used for displaying information on said character is transmitted by the player terminal 20 to the server device 10 based on such operational information.

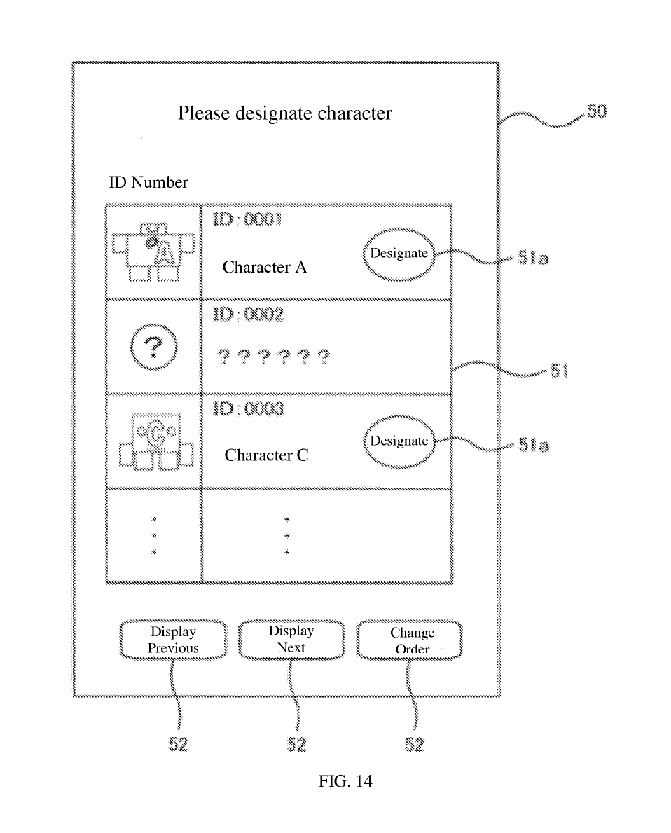

FIG. 14 is a diagram illustrating an exemplary game screen 50 used for designating characters. The screen data generation module 113 generates data for the game screen 50 used for designating characters based on the reference book information contained in each player's player information and the character information stored in the storage module 12. The game screen 50 used for designating characters has a character information display area 51 used for displaying partial information on each character, and control buttons 52 used to change the characters displayed on the screen. Character names, character images, and other information is listed in the order of the IDs in the character information display area 51 in association with the IDs of the characters the player has owned. When a character about which the player would like to obtain information is displayed in the character information display area 51, the player can designate (select) the character by pressing the Designate Button 51a displayed in conjunction with the character. It should be noted that for characters that the player has never owned heretofore, such information may be hidden, as shown in FIG. 14, and said characters may be impossible to designate. When the desired character is not displayed in the character information display area 51, the player can change the order of the characters and the type of the characters displayed on the screen by issuing screen-changing instructions with the help of the control buttons 52.

Subsequently, referring back to FIG. 13, the statistical data generation processing module 112 accesses the player information of the player who issued the request and acquires predetermined information (S102). Specifically, the level (or rank) of the player is acquired from the player information stored in the storage module 12 and at least one information item is acquired from the stage progression information. These information items constitute information representing the player's current stage of game progress.

The statistical data generation processing module 112 then extracts usage information for the character designated in S101 for each stage of the player's game progress (S103). As shown in FIG. 11, the usage information of the characters includes data concerning multiple players. Among these multiple players, there are high-level players and low-level players, players who have already cleared many stages and players who have not yet cleared many stages, and so on, and the stages of game progress are significantly different for different players. In this way, the information the players would like to know about a character is likely to be different for veteran players in advanced stages of game progress, than it is for beginner players who are not in advanced stages of game progress. Accordingly, in the present embodiment, the usage information is extracted by grouping the players according to the different stages of game progress. For example, to determine usage information for a certain character, the players are grouped into players who have a level (or rank) of 1 to 50, players who have a level of 51 to 100, players who have a level of 101 to 150, and so on, and the usage information is extracted respectively for each group. As a result, multiple usage information records are extracted, such as usage information for the player group with a level of 1 to 50, usage information for the player group with a level of 51 to 100, usage information for the player group with a level of 101 to 150, and so on.

It should be noted that grouping corresponding to the stage of game progress need not be uniform and the method of grouping may be changed for each character. For example, the higher a character's rarity is, the more detailed the grouping might be. In addition, grouping may be performed according to the rate of stage progression of each player, by referring to the stage progression information as an indication of the stage of game progress.

In addition, due to the fact that in the present embodiment the usage information is extracted based on information (proprietary character information) on the game content objects currently owned by the players, it becomes easy to obtain precise data appropriate for actual usage.

Subsequently, the statistical data generation processing module 112 aggregates the usage information extracted in S103 and generates statistical information in accordance with the player's stage of game progress (S104). Specifically, statistical information such as the average ownership period for the character, its favorite registration rate, average number of fusions, average number of awakenings, deck configuration rate, and various other types of information is produced by aggregating usage information extracted from the player group in the same stage of progress as the player who designated the character in S101. In the general case, when these values are higher, it means that the character is frequently used by the players. For example, a character with a long average ownership period can be said to have a value sufficient to own it for an extended period and, in addition, a character with a high favorite registration ratio can be said to be popular with many players.

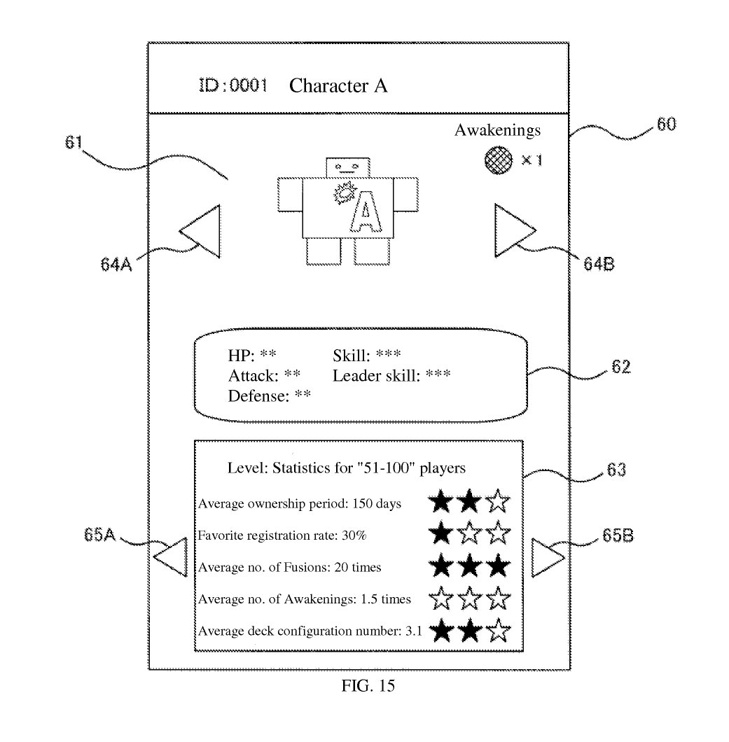

Subsequently, the statistical data generation processing module 112 uses the statistical information to generate value information (value information on the game content objects) that indicates the utility value of the characters (S105). The value information provides the player with a relative assessment of the value of the characters and is represented as the magnitude of a “recommendation score”, the number of “stars”, and other information (see FIG. 15). For example, with regard to the character's ownership period, if the average ownership period is 1 to 10 days, the recommendation score is (low), if the average ownership period is 11 to 50 days, the recommendation score is (medium), and if the average ownership period is 100 or more days, the recommendation score is (high), and so on. Although the standards used when generating the value information are configured in advance for each character, they can be appropriately changed. For example, when a new game content object (character) is introduced into the game or when the character becomes easily available in a lottery game, the relative value of the character may be subject to fluctuations, and the value information may be allowed to vary depending on such relative value fluctuations.

Subsequently, screen data used for displaying a game screen used to display character information on the player terminal 20 is generated by the screen data generation module 113 (S106). FIG. 15 is a diagram illustrating an exemplary game screen 60 used for displaying character information. The game screen 60 has a character display area 61, a parametric information display area 62, a statistical information display area 63, Character Change Buttons 64A and 64B, and Player Group Change Buttons 65A and 65B. Based on the character information stored in the storage module 12 and the proprietary character information contained in the player information, the screen data generation module 113 displays a character name and a character image in the character display area 61 and displays information on the character's attack strength and various other parameters in the parametric information display area 62. In addition, information such as the number of awakenings and number of fusions of said character may be displayed in the character display area 61. The screen data generation module 113 also displays at least one information item selected from the statistical information generated in S104 and value information generated in S105 in the statistical information display area 63.

The example of FIG. 15 displays statistical information on Character A aggregated for the player group with a level of 51 to 100. The player can precisely determine the utility of said character in the course of the game by checking statistical information on Character A, in the form of specific numerical values, aggregated based on the usage information of other players in the similar stage of game progress. Furthermore, in the example in FIG. 15, in addition to the statistical information, value information on Character A is displayed as the number of stars. For example, while the average period of ownership of Character A by other players in the similar stage of game progress is shown to be 150 days, it may be difficult to determine whether said period is long or short. In such cases, it is easier for the player to determine the utility of said Character A in a more direct manner if the number of stars or recommendation scores are displayed as value information.

Although the statistical information and value information displayed herein in the statistical information display area 63 is for the player group whose stage of game progress is similar to the player's, by manipulating the Player Group Change Buttons 65A and 65B, the player can also view statistical information and value information for groups in other stages of progress. For example, if the player provides input via the player terminal 20 using the Player Group Change Button 65B on the game screen 60 of FIG. 15, the screen data generation module 113 displays statistical information and value information on Character A aggregated for the player group with a level of 101 to 150 (in other words, the player group that is one stage higher in terms of the stage of progress) in the statistical information display area 63. As a result, the utility and evaluation of Character A for a player group with a more advanced stage of game progress can be used by the player as a guide. Conversely, statistical information for a player group in a less advanced stage of game progress can be displayed by manipulating Player Group Change Button 65A.

Subsequently, referring back to FIG. 13, the player terminal 20 determines whether or not input from the player has been provided via the Character Change Buttons 64A or 64B (S107). The process is then terminated if there has been no input (S107: No). On the other hand, if there has been input by the player (S107: Yes), the process advances to S108 in order to change the character for which statistical information is to be displayed.

Subsequently, the statistical data generation processing module 112 extracts usage information on the character for which change instructions were issued in S107, in other words, the newly designated character (S108). The Character Change Buttons 64A and 64B displayed on the game screen 60 in FIG. 15 are control buttons used to designate the characters pre-associated with the character (Character A in FIG. 15) on which information is being displayed at the moment. In other words, these are the control buttons used for displaying statistical information and the like on the character created by evolving the current character by fusion (the evolved character) or the character that existed prior to the evolution of the current character (the pre-evolved character). Upon accessing the character fusion information (see FIG. 5), the statistical data generation processing module 112 refers to the ID of the evolved character or pre-evolved character associated with the current character (Character A), in other words, the ID of the newly designated character, and extracts the usage information on said character.

The statistical data generation processing module 112 then uses the usage information extracted in S108 to generate statistical information on the newly designated character (S109).

Subsequently, the statistical data generation processing module 112 uses the statistical information to generate value information that indicates the utility value of the newly designated character (S110).

The screen data generation module 113 generates data for a game screen used for displaying information on the newly designated character (S111). By checking said game screen, the player can acquire information on the evolved and pre-evolved characters in advance, which makes it easier to determine whether or not the current character should be evolved. It should be noted that processes respectively similar to the processes explained in S103 to S106 are performed in S108 to S111.

Subsequently, the screen data generation module 113 determines whether or not the newly designated character satisfies a predetermined criterion (S112). The “predetermined criterion” may be, for example, the condition that heretofore the newly designated character has never been owned by the player. The process is terminated if the predetermined criterion is not satisfied (S112: No), in other words, if the player has owned the newly designated character. On the other hand, the process advances to S113 if the predetermined criterion is satisfied (S112: Yes), in other words, if the player has not owned the newly designated character.

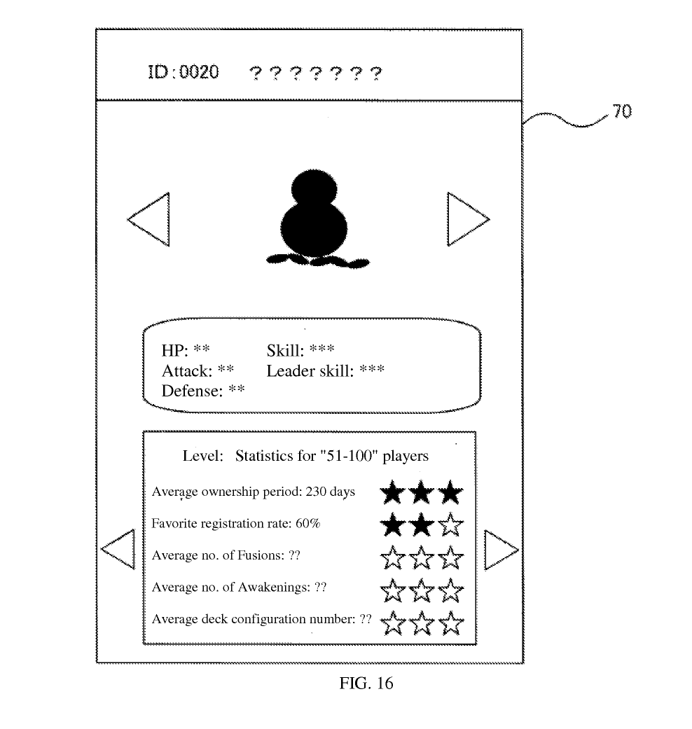

The screen data generation module 113 then carries out a hiding process intended to hide all or some of the information in the statistical information and value information on the newly designated character (S113). FIG. 16 is a diagram illustrating an exemplary game screen 70 used for displaying character information on which some of the information is hidden. In FIG. 16, some of the statistical information and value information is hidden. In addition, the character name and character image are also hidden. Since heretofore the player has not owned the newly designated character (e.g., an evolved character), for the player, said character is an unknown character. Hiding information on such an unknown character on the game screen makes it possible to stimulate the players' imagination and heighten their interest in said character. Furthermore, displaying some of the information so as to allow the players to get some idea of the utility of the character can cause the players to anticipate owning said character.

As described above, the game system 1 according to the present embodiment makes it possible to aggregate usage information on how a game content object designated by the player is used by other players and display it as statistical information and value information on the game screen. For this reason, the player can obtain precise information on how said game content object is used by other players and can readily make a determination as to the utility of the game content object without spending much time or effort. In addition, the players can acquire appropriate information corresponding to their own progress because the usage of the game content objects is aggregated according to the stage of game progress based on the level and stage clearing information for each player.

### Other Embodiments

The foregoing embodiment was intended to facilitate the understanding of the present invention and is not to be construed as limiting of the present invention. The present invention can be modified and improved without departing from its spirit and the present invention includes equivalents thereto. In particular, the embodiments described below are also included in the present invention.

### <Regarding Generation of Statistical Information Display and Other Display Screens>

Although in the above-described embodiment usage information for each character was extracted and aggregated and a screen used for displaying statistical information and value information was generated with the proviso that a character-designating operation had to be received from the player, the present invention is not limited thereto. For example, when the player acquires a certain character in a lottery game, a screen used for displaying statistical information and value information may be generated based on usage information for said character.

In such a case, first of all, in response to a lottery drawing request from the player, the game content provision module 111C selects a game content object from multiple game content objects and stores the selected game content object in association with the player, thereby providing said game content object to the player. Subsequently, upon having designated the game content object provided to the player, the processes of S102 to S113 of FIG. 13 are executed in a sequential manner. This makes it possible for the player to easily obtain precise information on the utility of the game content object (character) acquired in the lottery game, and the player can readily determine how to use this game content object.

### <Regarding Usage Information>

Although in the above-described embodiment the usage information was extracted based on predetermined information (for example, number of fusions, number of awakenings, etc.) contained in the information stored as each player's proprietary character information, the present invention is not limited thereto. For example, information such as the number of times the character has been used in the battle game, the number of times skills have been deployed in the battle game, the number of times the character has been registered as a leader character, and the number of times the character has been registered as a support character may be aggregated as usage information. Since all such information represents information that indicates the usefulness of the character in a battle game, it can be used as a guide for the players in determining the utility of said character.

In this case, information on the number of uses of the character, the number of skill deployments, as well as information on whether it has been registered as a leader character or a support character in the battle game is stored as proprietary character information in association with the character ID. The statistical data generation processing module 112 then accesses said information and extracts it for each character, thereby generating usage information.

### <Regarding Aggregation Periods for Various Types of Data>

Although in the above-mentioned embodiment the extraction of the usage information was performed using current data from each player's proprietary character information and the statistical information and value information were aggregated based on said usage information, the present invention is not limited thereto. For example, the statistical information, and the like, may be aggregated by delimiting the data of the proprietary character information separately for certain periods. For example, the statistical data generation processing module 112 would extract the past week's data or yesterday's data and perform aggregation in the form of statistical information and value information for these periods. In addition, the proprietary character information itself may be stored separately for certain periods.

Using such data makes it possible to display the usage of the character by the players as the latest information. Being able to refer to the latest statistical information makes it easier for the player to make even better decisions regarding the character. For example, if a certain character was frequently used one year ago, but has not been used much recently, it is easier for the player to precisely understand the latest usage of said character because value information of said character from the past week is displayed as being lower than such value information from one year ago.

### <Server Device>

In the present embodiments as described above, the explanations are given with reference to a game system 1 equipped with a single server device 10 as an example of a service device. The invention, however, is not limited thereto and a game system 1 equipped with multiple server devices 10, as an example of server devices, may also be used. In other words, multiple server devices 10 may be connected over a network 2 and these server devices 10 may perform various types of processing in a distributed manner.

### <Information Processing Device>

In the game system 1 used in the present embodiment as described above, the explanations are given with reference to a case in which various types of information processing are carried out by directing the server device 10 and the player terminals 20 to cooperate based on a game program (e.g., non-transitory computer-readable medium containing instructions stored in a storage and executable on a hardware device). The invention, however, is not limited thereto and the above-mentioned various types of information processing may be carried out based on the game program using the server device 10 alone or the player terminals 20 alone as information processing devices.

In addition, a configuration may be used in which the player terminals 20 support part of the information processing device functionality. In such a case, the server device 10 and player terminals 20 constitute an information processing device.

It should be noted that the information processing device is an example of a computer equipped with a processor and a memory.

### DESCRIPTION OF THE REFERENCE NUMERALS

1 Game system
2 Network
10 Server device
11 Control module
12 Storage module
13 Input module
14 Display module
15 Communication module
20 Player terminal
21 Terminal control module
22 Terminal storage module
23 Terminal input module
24 Terminal display module
25 Terminal communication module
50 Game screen
51 Character information display area
51a Designate Button
52 Control button
60 Game screen
61 Character display area
62 Parametric information display area
63 Statistical information display area
64A Character Change Button
64B Character Change Button
65A Player Group Change Button
65B Player Group Change Button
70 Game screen
111 Game progression processing module
111A Battle processing module
111B Fusion processing module
111C Game content provision module
112 Statistical data generation module
113 Screen data generation module

1. An information processing device comprising:
a storage module that stores usage information on game content objects used in a game by each of a plurality of players, in association with each player;
a statistical data generation module that generates statistical information on the usage of the game content objects by aggregating the usage information on each of the plurality of game content objects; and
a screen data generation module that generates data for game screens, which includes at least one of statistical information on transformed game content objects pre-associated with the game content objects designated by the players when operations for designating game content objects are performed by the players, or value information on the game content objects that indicates the utility value of the transformed game content objects based on said statistical information.

2. The information processing device according to claim 1, wherein the statistical data generation module aggregates the usage information on each of the plurality of game content objects separately for each stage of progress in the game of each player, and
the screen data generation module generates data for game screens, which includes at least one of value information on the game content objects or statistical information on the game content objects designated by the players in accordance with the stage of progress of the players who perform operations for designating the game content objects.

3. The information processing device according to claim 1, wherein the statistical data generation module aggregates only the usage information on the game content objects the players currently own, from among the game content objects the players have used in the game.

4. The information processing device according to claim 1, wherein said information processing device is provided with a game content provision module providing the players with game content objects selected from a plurality of game content objects, and
the screen data generation module generates data for game screens, which includes at least one of value information on the game content objects or statistical information on the game content objects provided when said game content objects are provided to the players.

5. The information processing device according to claim 1, wherein all or some of the value information on the game content objects or statistical information on the game content objects designated by the players when operations for designating game content objects are performed by the players is controlled by the screen data generation module based on predetermined criteria such that the information is prevented from being displayed on the screen.

6. A non-transitory computer-readable medium containing instructions stored in a storage and executable on a hardware device for a game program, the instructions comprising:
a process intended to record usage information on game content objects used in a game by each of a plurality of players in a storage module, in association with each player;
a statistical data generation process for generating statistical information on the usage of the game content objects by aggregating the usage information on each of the plurality of game content objects; and
a screen data generation process for generating data for game screens, which includes at least one of statistical information on transformed game content objects pre-associated with the game content objects designated by the players when operations for designating game content objects are performed by the players, or value information on the game content objects that indicates the utility value of the transformed game content objects based on said statistical information.
